(19) United States
(12) Patent Application Publication
(10) Pub. No.: US 2007/0125308 A1
(43) Pub. Date: Jun. 7, 2007

(54) Litter box exhaust system

(76) Inventor: George T. Goldston, Bumpass, VA (US)

Correspondence Address: Galasso & Associates, LP, P.O. Box 26503, Austin, TX, 78755-0503, US

(21) Appl. No.: 11/633,891

(22) Filed: Dec. 5, 2006

Related U.S. Application Data
(60) Provisional application No. 60/742,341, filed on Dec. 5, 2005.

(51) Int. Cl. A01K 29/00

(52) U.S. Cl. 119/165

(57) ABSTRACT

Litter Box Exhaust System is a ventilated litter box container with an exhaust fan on top and a fragrance dispersion holder and/or container in the interior. To use the preferred embodiment of Litter Box Exhaust System, a user simply chooses a location for a litter box and places it in the container. A fragrance can is then placed in the holder and the fan is started. A user can turn off the fan using a power switch to conserve power whenever desired.

### CROSS REFERENCE TO RELATED APPLICATIONS

This U.S. Non-Provisional Patent Application claims priority to U.S. Provisional Patent Application No. 60/742,341 entitled “Litter Box Exhaust System” filed on Dec. 5, 2005.

### FIELD OF THE DISCLOSURE

The disclosures made herein relate generally to the pet accessory industry. The invention discussed herein is in the general classification of ventilated litter boxes and accessories.

### BACKGROUND

Many households in the United States have one or more pets. Cats and dogs are among the most popular pets. In the United States, there are an estimated seventy million cats and fifty-five million dogs. Many individuals consider their pets to be members of the family and spend enormous sums of money for healthcare, food, toys, and other pet accessories.

Many pet owners like to ensure the comfort of their pets by allowing the animals to live in the home. Household pets are constant companions and are also healthier as they do not have to deal with the extremes of weather or come into contact with disease carrying insects or other wildlife. It is often necessary for pets such as cats to relieve themselves while inside the house. Litter boxes are necessities for households with indoor cats.

Unfortunately, traditional litter boxes need constant attention and cleaning to prevent unpleasant odors from accumulating in the home. Even with constant attention, litter boxes often produce undesirable smells, particularly in unventilated areas.

To reduce these problems, ventilated litter boxes and litter box containers and automatic cleaning litter boxes have been invented. However, ventilated litter boxes and containers often require costly installation to provide venting ducts to the outdoors or involve complicated filter systems. Automatic sweeping litter boxes are also costly and do not completely prevent odors from emanating from a litter box.

Hence, there is a need in the art for an easy to use, inexpensive, durable and effective ventilated litter box or litter box container that can distribute odors and provide a masking, pleasant fragrance to the area surrounding the litter box.

### SUMMARY OF THE DISCLOSURE

Litter Box Exhaust System is a ventilated litter box container with an exhaust fan on top and a fragrance dispersion holder and/or container in the interior.

The principal object of this invention is to provide an exhaust system and fragrance dispenser for use with a litter box.

Another object of this invention is to provide an affordable exhaust system and fragrance dispenser for use with a litter box.

Another object of this invention is to provide an exhaust system and fragrance dispenser that is easily and quickly employed with a litter box.

Another object of this invention is to provide a safe exhaust system and fragrance dispenser for use with a litter box.

Another object of this invention is to provide a quiet exhaust system for use with a litter box.

Yet another object of this invention is to provide a durable exhaust system and fragrance dispenser for a litter box.

### BRIEF DESCRIPTION OF THE DRAWINGS

FIG. 1 depicts a frontal view of the preferred embodiment of the present invention with the top propped open.

FIG. 2 depicts a top view of the bottom of the preferred embodiment of the present invention.

### DETAILED DESCRIPTION OF THE DRAWINGS

The preferred embodiment of Litter Box Exhaust System is comprised of at least some of the following: a container with an opening on the front and swinging pet door attached above the opening, an exhaust fan on the top of the container with a protective screen, a fragrance can holder in the interior of the container and a power source for the exhaust fan. The preferred embodiment will also have a second fan on an interior wall behind the fragrance can holder and a second power source.

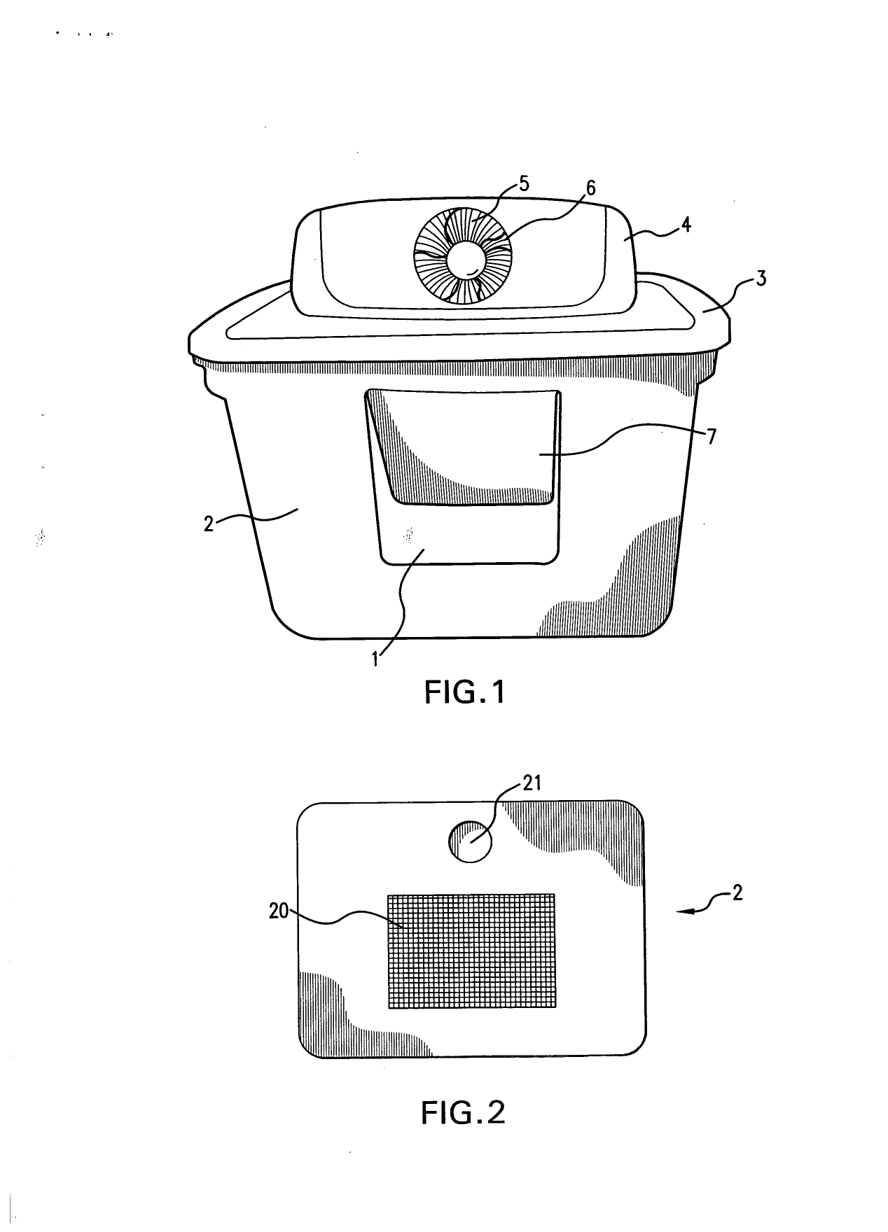

In the preferred embodiment of the invention, shown in FIG. 1, an approximately square opening 1 is cut into a rectangular container 2 made of plastic. The container 2 is twenty-five inches in depth, fifteen inches in width and fifteen inches in height in the preferred embodiment though a variety of sizes are possible. The approximately square opening 1 has approximately eight inch sides. A swinging pet door 7 is attached above the square opening 1 to allow it to be closed most of the time to prevent odor from escaping through the approximately square opening 1. The pet door 7 is dimensioned to conform to the size of the approximately square opening 1 and is made of plastic in this preferred embodiment. The pet door 7 is attached via hinges in this preferred embodiment though a variety of attaching mechanisms are well known in the art and could permit the pet door 7 to swing open and shut on the container 2.

A removable lid 3 made of plastic covers the container 2. The removable lid 3 has a removable top 4 made of plastic containing an exhaust fan 5 and a protective screen 6 to prevent injuries to a pet or pet owner. The removable top 4 extends approximately five inches above the removable lid 3 in a pyramid fashion in this preferred embodiment though a variety of shapes and arrangements may be utilized. The exhaust fan 5 is wired to a power source, a battery located in the removable top 4, in this preferred embodiment.

A power switch (not shown) is located on the removable top 4 to prevent excessive drain on the battery when the exhaust fan 5 does not need to be running. The exhaust fan 5 of this preferred embodiment is low noise to prevent alarming a pet and discouraging use of the litter box located in the interior of the container 2.

FIG. 2 shows the preferred embodiment of the bottom of the container described in FIG. 1. A mesh screen 20 is located on the bottom of the container 2 to allow air-flow through the bottom of the container 2 to help with ventilation. The mesh screen 20 is approximately square with six inch sides. A fragrance can holder 21 that is approximately circular is cut into the bottom of the container 21 and is designed to hold a can of air freshener oil or other appropriate fragrance dispenser.

To aide in the circulation of the air freshener, a second fan with a second screen can be placed behind the fragrance can holder and attached to a second power source located on the container. A power switch may also be located on the container to prevent the second fan from constantly running.

To use the preferred embodiment of Litter Box Exhaust System, a user simply chooses a location for the litter box and removes the lid from the container. The user then places the litter box inside the container. A fragrance can is then placed in the holder and the second fan is started. The lid is then placed back on the container and the exhaust fan is started. A user can turn off either fan to conserve power whenever desired. The device could also simply be used as a substitute to the conventional litter box rather than placing a litter box within the container.

The components of Litter Box Exhaust System may vary but will likely use metal, plastic and electrical materials. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Litter Box Exhaust System can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components used with the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of metals, plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A ventilation device for litter boxes comprising:
(a) a container;
(b) an opening on the container;
(c) a lid on the top of the container containing a fan;
(d) a power source operatively connected to the fan; and
(e) a holder located within the container.

2. The device of claim 1 wherein the opening is square.

3. The device of claim 1 wherein the container is rectangular.

4. The device of claim 1 wherein the container is made of plastic.

5. The device of claim 1 further comprising
a swinging pet door attached above the opening.

6. The device of claim 1 wherein a protective screen covers the fan.

7. The device of claim 1 wherein the power source is a battery.

8. The device of claim 1 further comprising
a power switch located on the lid.

9. The device of claim 1 further comprising
a mesh screen located on the bottom of the container.

10. The device of claim 1 further comprising
a fragrance can located in the holder.

11. The device of claim 1 further comprising
a second fan operatively connected to a second power source and located in the interior of the container behind the holder.

12. The device of claim 11 wherein the second power source is a battery.

13. The device of claim 11 further comprising
a second power switch located on the container to operate the second fan.

14. The device of claim 11 further comprising
a second screen located over the second fan.

15. The device of claim 1 wherein the lid is removable.

16. A ventilation device for litter boxes comprising:
(a) a container that is approximately rectangular and plastic;
(b) an opening that is approximately square in the front of the container;
(c) a removable lid on the top of the container having a removable top containing a fan;
(d) a battery operatively connected to the fan;
(e) a holder located within the container;
(f) a swinging pet door attached above the opening;
(g) a protective screen covering the fan;
(h) a power switch to operate the fan;
(i) a mesh screen located on the bottom of the container;
(j) a second fan operatively connected to a second battery and located in the interior of the container behind the holder;
(k) a second power switch located on the container to operate the second fan; and
(l) a second protective screen to cover the second fan.
